(19) United States
(12) Patent Application Publication
(10) Pub. No.: US 2024/0079605 A1
(43) Pub. Date: Mar. 7, 2024

(54) ULTRA-STABLE REFERENCE ELECTRODE FOR ENERGY STORAGE AND CONVERSION SYSTEMS

(71) Applicant: Battelle Memorial Institute, Richland, WA (US)

(72) Inventors: Qian Huang, Richland, WA (US); David M. Reed, Richland, WA (US)

(73) Assignee: Battelle Memorial Institute, Richland, WA (US)

(21) Appl. No.: 18/459,322

(22) Filed: Aug. 31, 2023

Related U.S. Application Data
(60) Provisional application No. 63/404,052, filed on Sep. 6, 2022.

(51) Int. Cl. H01M 4/92; H01M 8/18

(52) U.S. Cl. CPC H01M 4/92; H01M 4/925; H01M 8/188

(57) ABSTRACT

A reference electrode assembly includes a reference electrode, a counter electrode, and a variable resistor. The reference electrode comprises a foil of a first metal or a foil coated with the first metal, has a width ≥0.5 mm and a length ≥the width. A surface of the reference electrode has an average roughness (Rₐ)≤1 μm. The counter electrode comprises a foil of a second metal or a foil coated with the second metal. The reference and counter electrodes are spaced apart. The reference electrode is configured to be electrically coupled directly or indirectly to a (−) power terminal of an external power source, and the counter electrode is configured to be electrically coupled directly or indirectly to a (+) power terminal of the external power source. The variable resistor is positioned between the external power source and either the counter electrode or the reference electrode.

### CROSS REFERENCE TO RELATED APPLICATION

This application claims the benefit of the earlier filing date of U.S. Provisional Application No. 63/404,052, filed Sep. 6, 2022, which is incorporated herein by reference in its entirety.

### ACKNOWLEDGMENT OF GOVERNMENT SUPPORT

This invention was made with Government support under Contract DE-AC05-76RL01830 awarded by the U.S. Department of Energy. The Government has certain rights in the invention.

### FIELD

This disclosure concerns a reference electrode assembly, which may be used in a redox flow battery system, a fuel cell, and other energy storage and conversion systems.

### BACKGROUND

One major technical obstacle haunting redox flow battery (RFB) technology, e.g., vanadium RFB (VFRB) technology, is the substantial capacity decay that occurs during long-term cycling. This is associated with complicated degradation mechanisms inside the VRFB, including electrolyte crossover, electrolyte precipitation, electrode oxidation, membrane degradation, and/or potential degradation from other inactive components (e.g., bipolar plates, gaskets, current collectors). Conventionally, electrochemical performances of VRFBs have been evaluated in full cell mode, which makes it difficult to isolate contributions from individual electrodes and the cell degradation mechanism from each electrode challenging to identify. Some internal reference electrodes, such as single Pt wires or dynamic hydrogen electrodes can decouple the cathode and anode potential drop and impedance. However, these internal reference electrodes suffer from shifting potentials during cycling of the RFB since the electrodes are easily influenced or contaminated by the surrounding environments inside the cell such as the continuous changing of the components (concentration and valence of vanadium ion) in the electrolytes. A need exists for a more stable internal reference electrode, particularly a stable internal reference electrode capable of decoupling the cathode and anode to allow monitoring of the individual electrodes.

### SUMMARY

Aspects of a reference electrode assembly, which may be used in a redox flow battery system, a fuel cell, or other energy storage and conversion systems, are disclosed. In some aspects, the reference electrode assembly includes (i) a reference electrode comprising a foil of a first metal or a coated foil that is coated with the first metal, a surface of the reference electrode having an average roughness (Rₐ)≤1 μm, the reference electrode having a width ≥0.5 mm and a length that is greater than or equal to the width; (ii) a counter electrode comprising a foil of a second metal or a coated foil that is coated with the second metal; and (iii) a variable resistor. The reference electrode and the counter electrode are in a spaced-apart relationship. The reference electrode is configured to be electrically coupled directly or indirectly to a negative (−) power terminal of an external power source. The counter electrode is configured to be electrically coupled directly or indirectly to a positive (+) power terminal of the external power source. The variable resistor has a first terminal that is electrically coupled to the counter electrode or to the reference electrode, and a second terminal that is configured to be electrically coupled to a power terminal of the external power source. In some implementations, the counter and reference electrodes are positioned adjacent to one another and are separated by a void space of from 1 mm to 30 mm, as measured from adjacent edge surfaces of the reference and counter electrodes.

In any of the foregoing or following aspects, the counter electrode may have (i) an average roughness (Rₐ)≤1 μm, or (ii) a width ≥0.5 mm; or (iii) a length that is greater than or equal to the width, or (iv) any two or more of (i), (ii), and (iii). In any of the foregoing or following aspects, the variable resistor may have a maximum resistance of 10 MΩ.

In any of the foregoing or following aspects, each of the reference electrode and the counter electrode independently may have a width of from 1 mm to 30 mm and a length of ≥5 mm. In any of the foregoing or following aspects, a thickness of the reference electrode may be less than the width of the reference electrode and also is ≤3 mm, and a thickness of the counter electrode may be less than the width of the reference electrode and also is ≤3 mm.

In certain aspects, the first and second metals are the same, Ra values of the reference and counter electrodes are the same, widths of the reference and counter electrodes are the same, lengths of the reference and counter electrodes are the same, and thicknesses of the reference and counter electrodes are the same.

Some implementations of a redox flow battery system include a cathode; an anode; a separator positioned between the cathode and the anode, the separator comprising two ion-conductive membranes; and a reference electrode assembly according to claim 1, wherein at least a portion of the reference electrode and at least a portion of the counter electrode are positioned between the two ion-conductive membranes of the separator. In some aspects, distal ends of the reference and counter electrodes of the reference electrode assembly are spaced apart from adjacent surfaces of the cathode and the anode by a distance of at least 2 mm.

The foregoing and other objects, features, and advantages of the invention will become more apparent from the following detailed description, which proceeds with reference to the accompanying figures.

### BRIEF DESCRIPTION OF THE DRAWINGS

FIGS. 1A and 1B are schematic diagrams of two exemplary reference electrode assemblies as disclosed herein.

FIGS. 2A and 2B are perspective views of an exemplary foil electrode (FIG. 2A) and an exemplary coated foil electrode (FIG. 2B), as disclosed herein.

FIG. 3 is a schematic diagram of a portion of a redox flow battery system and an exemplary reference electrode assembly as disclosed herein, wherein portions of the reference and counter electrodes are inserted between two ion-conductive membranes of a separator.

FIG. 4 is a top cross-sectional view taken along line A-A of FIG. 3.

FIG. 5 shows profilometer measurements of a Pt foil with a smooth surface.

FIG. 6 shows profilometer measurements of a Pt foil with a rough surface.

FIG. 7 is a graph of voltage profiles (vs. time) with internal and external reference electrodes: individual electrode (cathode or anode) voltage vs. an exemplary reference electrode as disclosed herein for the initial two cycles.

FIG. 8 is a graph showing charge-discharge voltage profiles vs. time of a full cell (cathode vs anode) and its individual electrodes (cathode or anode) vs. a dynamic hydrogen electrode with Pt wires during long-term cycling of a scaled vanadium redox flow battery (VFRB) (49 cm² active area).

FIG. 9 is a graph showing charge-discharge voltage profiles vs. time of a full cell (cathode vs anode) and its individual electrodes (cathode or anode) vs. a dynamic hydrogen electrode with smooth Pt foil electrodes during long-term cycling of a scaled VFRB (49 cm² active area).

FIG. 10 is a graph showing charge-discharge voltage profiles vs. time of a full cell (cathode vs anode) and its individual electrodes (cathode or anode) vs. a dynamic hydrogen electrode with rough Pt foil electrodes during long-term cycling of a scaled VFRB (49 cm² active area).

FIGS. 11A and 11B show charge-discharge voltage profiles (vs. time) of a full cell and its individual electrodes (cathode or anode) vs. RE (DHE, Ag/AgCl (+) or Ag/AgCl (−)) of a scaled vanadium redox flow battery (49 cm² in active area): for the initial 10 cycles (FIG. 11A), and for the 2^{nd} cycle (FIG. 11B), the enlarged area highlighted in FIG. 11A. Ag/AgCl (+) and Ag/AgCl (−) are the Ag/AgCl reference electrodes that are in the inlet of catholyte and anolyte respectively.

FIGS. 12A-12C show voltage profiles (vs. time) of a full cell and its individual electrodes (cathode or anode) vs. DHE (FIG. 12A), Ag/AgCl (+) in the catholyte inlet (FIG. 12B), or Ag/AgCl (−) in the anolyte inlet (FIG. 12C) over the initial 80 cycles (120 hours).

FIGS. 13A and 13B show cell performances of an all-vanadium RFB using a commercial electrolyte with V (1.6 M) and N212 double membranes: charge and discharge capacities as a function of cycle number (FIG. 13A); and Coulombic efficiency (CE), voltage efficiency (VE), and energy efficiency (EE) as a function of cycle number (FIG. 13B).

FIG. 14 is a graph shown total vanadium ion concentration of catholyte and anolyte as a function of cycle number, measured by inductively coupled plasma (ICP) after discharge.

FIG. 15 shows charge and discharge voltage profiles as a function of capacity throughout 500 cycles in a full cell (left panels), individual electrodes vs. a DHE electrode assembly (middle panels), and individual electrodes vs. Ag/AgCl (+) (right panels).

FIGS. 16A-16C show open circuit voltage (FIG. 16A), overpotentials (ΔV) (FIG. 16B), and the relative proportion of overpotential (FIG. 16C) at the top of charge (TOC) and bottom of discharge (BOD) as a function of cycle numbers for the full cell and individual electrode (cathode or anode vs. DHE). For FIG. 16A, the curve #1 is the difference of OCV between cathode and anode. For FIG. 16B, the curve #1 is the sum of overpotential of individual electrodes (cathode+anode).

FIGS. 17A-17C show polarization curves as a function of cycle numbers for a full cell (FIG. 17A), cathode vs. DHE (FIG. 17B), and anode vs. DHE (FIG. 17C).

FIGS. 18A-18H show OCV at the top of charge (TOC) and bottom of discharge (BOD) as a function of cycle numbers for the full cell (FIGS. 18A, 18B) and individual electrode (cathode or anode) vs. different reference electrodes: DHE (FIGS. 18C, 18D), Ag/AgCl (+) (FIGS. 18E, 18F) and Ag/AgCl (−) (FIGS. 18G, 18H).

FIGS. 19A and 19B show polarization curves as a function of cycle numbers for cathode vs. Ag/AgCl (+) (FIG. 19A) and anode vs. Ag/AgCl (+) (FIG. 19B).

### DETAILED DESCRIPTION

Aspects of a reference electrode assembly are disclosed. The reference electrode assembly is useful for monitoring and evaluating performance of redox flow batteries, such as vanadium redox flow batteries, or in fuel cells or other energy storage and conversion systems. Advantageously, some aspects of the disclosed reference electrode assembly decouple signals from the cathode and anode and allow in-situ monitoring of individual electrodes to determine which electrode is causing performance degradation during long-term cycling of the battery, fuel cell, or other energy storage and conversion system.

### I. DEFINITIONS AND ABBREVIATIONS

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing embodiments from discussed prior art, the embodiment numbers are not approximates unless the word “about” is recited.

Although there are alternatives for various components, parameters, operating conditions, etc. set forth herein, that does not mean that those alternatives are necessarily equivalent and/or perform equally well. Nor does it mean that the alternatives are listed in a preferred order unless stated otherwise.

Definitions of common terms in chemistry may be found in Richard J. Lewis, Sr. (ed.), Hawley's Condensed Chemical Dictionary, published by John Wiley & Sons, Inc., 2016 (ISBN 978-1-118-13515-0).

In order to facilitate review of the various embodiments of the disclosure, the following explanations of specific terms are provided:

Anode: An electrode through which electric charge flows into a polarized electrical device. From an electrochemical point of view, negatively-charged anions move toward the anode and/or positively-charged cations move away from it to balance the electrons leaving via external circuitry.

Cathode: An electrode through which electric charge flows out of a polarized electrical device. From an electrochemical point of view, positively charged cations invariably move toward the cathode and/or negatively charged anions move away from it to balance the electrons arriving from external circuitry.

Dynamic hydrogen electrode (DHE): A reference electrode that utilizes the potential of the hydrogen evolution reaction (HER). A DHE is a subtype of standard hydrogen electrodes. The DHE simulates a reversible hydrogen electrode with ˜20 mV to ˜40 mV more negative potential.

Ra: Average roughness, an average of how much each point on a surface deviates in height from a mean height of the surface. Ra may be measured by any suitable means, such as by use of a profilometer.

Reference electrode: An electrode that has a stable and well-known electrode potential or whose potential is arbitrarily taken as zero. The reference electrode is used as a reference for measurement by other electrodes.

Separator: A battery separator is one or more porous sheets or films placed between the anode and cathode. It prevents physical contact between the anode and cathode while facilitating ionic transport.

Variable resistor: A resistor having an adjustable resistance value, typically used to vary the amount of current that flows through a circuit.

VRFB: vanadium redox flow battery

### II. REFERENCE ELECTRODE ASSEMBLY

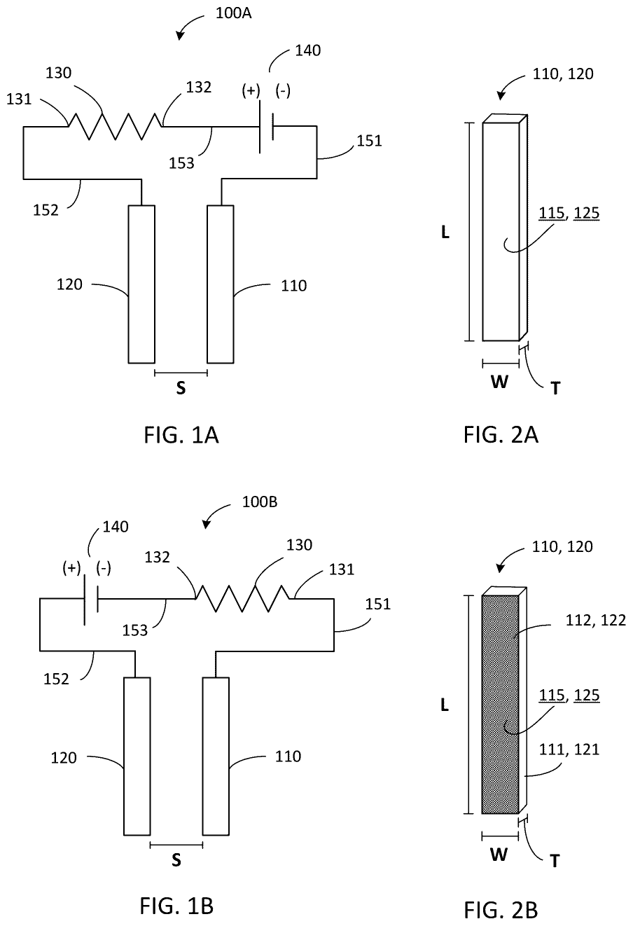

With reference to FIGS. 1A and 1B, aspects of a reference electrode assembly 100A, 100B include a reference electrode 110, a counter electrode 120, and a variable resistor 130. The reference electrode 110 and counter electrode 120 are in a spaced-apart relationship with a space S between adjacent edge surfaces of the reference electrode 110 and counter electrode 120. The reference electrode 110 is configured to be electrically coupled directly or indirectly to a negative (−) power terminal of an external power source 140. The counter electrode 120 is configured to be electrically coupled directly or indirectly to a positive (+) power terminal of the external power source 140.

The variable resistor 130 has a first terminal 131 electrically coupled to the counter electrode 120 or the reference electrode 110, and a second terminal 132 that is configured to be electrically coupled to a power terminal of the external power source 140. In some aspects, the variable resistor 130 is positioned between the counter electrode 120 and the external power source 140, as shown in FIG. 1A. In the configuration of FIG. 1A, the reference electrode 110 is electrically coupled directly to the (−) terminal of the external power source 140, and the counter electrode 120 is electrically coupled to the first terminal 131 of the variable resistor 130 and indirectly to the (+) power terminal. In other aspects, the variable resistor 130 is positioned between the reference electrode 110 and the external power source 140, as shown in FIG. 1B. In the configuration of FIG. 1B, the reference electrode 110 is electrically coupled to the first terminal 131 of the variable resistor 130 and indirectly to the (−) terminal of the external power source 140, and the counter electrode 120 is electrically coupled directly to the (+) power terminal.

In any of the foregoing or following aspects, electrical coupling can be performed by any suitable means. In some implementations, electrical coupling is provided by electrically conductive wires or filaments 151, 152, 153 as shown in FIGS. 1A and 1B. The wires or filaments may be any suitable electrically conductive material, including but not limited to Pt, Au, Pd, Cu, Al, Ag, or any combination thereof. By “combination” is meant that wires 151, 152, and 153 may be alloys comprising any two or more of Pt, Au, Pd, Cu, Al, and Ag.

The reference electrode 110 comprises a foil of a first metal or a coated foil that is coated with the first metal. The first metal comprises a hydrogen evolution reaction (HER) electrocatalyst. The counter electrode 120 comprises a foil of a second metal or a coated foil that is coated with the second metal. In any of the foregoing or following aspects, the first metal and second metal independently may comprise Pt, Au, Pd, Ir, Rh, or any combination (alloy) thereof. The first and second metals may be the same or different from one another. In some implementations, the first metal and the second metal are Pt.

As shown in FIGS. 2A and 2B, each of the reference electrode 110 and counter electrode 120 has a width W, a length L, and a thickness T. The widths, lengths, and thicknesses of the reference and counter electrodes 110, 120 may be the same or different from one another. By “the same” is meant that the values differ by less than ±5% relative to one another. Thus, for example, when the widths are the same, the width of the counter electrode is 0.95-1.05× the width of the reference electrode. In some aspects as shown in FIG. 2B, the reference electrode 110 is a coated foil electrode comprising a substrate foil 111 and a coating 112 of the first metal on at least one surface of the substrate foil 111. In some aspects, the counter electrode 120 is a coated foil electrode comprising a substrate foil 121 and a coating 122 of the second metal on at least one surface of the substrate foil 121 (FIG. 2B). In the implementations of FIG. 2B, the thickness T is a combined thickness of the substrate foil 111, 121 and coating 112, 122. The coating 112 comprises an HER electrocatalyst. In certain implementations, the coating 112 and coating 122 independently comprise Pt, Au, Pd, Ir, Rh, or any combination (alloy) thereof. In some examples, the coating 112 and coating 122 are Pt. In any of the foregoing or following aspects, the substrate foil 111, 121 independently may comprise any metal foil. Exemplary substrate foils 111, 121 include, but are not limited to, Al, Cu, Ni, Ag, or any combination (alloy) thereof.

A surface 115 of the reference electrode 110 has an average roughness (Rₐ)≤1 μm. In some aspects, Rₐ≤500 nm, 300 ≤nm, or ≤200 nm. In some implementations, Rₐ is in a range having endpoints selected from 10 nm, 25 nm, 50 nm, 100 nm, 150 nm, 200 nm, 250 nm, 300 nm, 350 nm, 400 nm, 450 nm, 500 nm, 600 nm, 700 nm, 800 nm, and 1 μm, wherein the range is inclusive of the endpoints. In certain aspects, Rₐ is 10 nm to 500 nm, 10 nm to 300 nm, 10 nm to 200 nm, 25 nm to 200 nm, 50 nm to 200 nm, or 100 nm to 200 nm.

In any of the foregoing or following aspects, a surface 125 of the counter electrode 120 may have an average roughness (Rₐ)≤1 μm. In some aspects, Rₐ≤500 nm, ≤300 nm, or ≤200 nm. In some implementations, Rₐ is in a range having endpoints selected from 10 nm, 25 nm, 50 nm, 100 nm, 150 nm, 200 nm, 250 nm, 300 nm, 350 nm, 400 nm, 450 nm, 500 nm, 600 nm, 700 nm, 800 nm, and 1 μm, wherein the range is inclusive of the endpoints. In some implementations, the Rₐ values of the reference electrode surface 115 and the counter electrode surface 125 are the same. In other implementations, the Ra values of the reference electrode surface 115 and the counter electrode surface 125 are different.

The reference electrode 110 has a width W≥0.5 mm and a length L that is greater than or equal to the width (see, e.g., FIGS. 2A, 2B). In some aspects, the width W is ≥1 mm. In some implementations, the width W is in a range having endpoints selected from 0.5 mm, 1 mm, 1.5 mm, 2 mm, 2.5 mm, 3 mm, 4 mm, 5 mm, 6 mm, 7 mm, 8 mm, 9 mm, and 10 mm, wherein the range is inclusive of the endpoints. In certain aspects, the width W is 1 mm to 10 mm, such as 2 mm to 8 mm or 4 mm to 6 mm.

In any of the foregoing or following aspects, the counter electrode 120 may have a width W ≥0.5 mm. Advantageously, the counter electrode 120 may have a length L greater than or equal to the width. In some aspects, the width W is ≥1 mm. In some implementations, the width W is in a range having endpoints selected from 0.5 mm, 1 mm, 1.5 mm, 2 mm, 2.5 mm, 3 mm, 4 mm, 5 mm, 6 mm, 7 mm, 8 mm, 9 mm, and 10 mm, wherein the range is inclusive of the endpoints. In certain aspects, the width W is 1 mm to 10 mm, such as 2 mm to 8 mm or 4 mm to 6 mm. In some implementations, the widths of the reference electrode 110 and the counter electrode 120 are the same. In other implementations, the widths of the reference electrode 110 and the counter electrode 120 are different.

The reference electrode 110 has a length L ≥the width W. In some aspects, the length L is ≥5 mm, ≥10 mm, or ≥20 mm. In some implementations, the length L is in a range having endpoints selected from 5 mm, 10 mm, 15 mm, 20 mm, 25 mm, 30 mm, 35 mm, and 40 mm, wherein the range is inclusive of the endpoints. In certain examples, the length L is 5 mm to 40 mm, such as 5 mm to 30 mm, 10 mm to 30 mm, or 15 mm to 25 mm.

In any of the foregoing or following aspects, the counter electrode 120 may have a length L ≥the width W. In some aspects, the length L is ≥5 mm, ≥10 mm, or ≥20 mm. In some implementations, the length L is in a range having endpoints selected from 5 mm, 10 mm, 15 mm, 20 mm, 25 mm, 30 mm, 35 mm, and 40 mm, wherein the range is inclusive of the endpoints. In certain examples, the length L is 5 mm to 40 mm, such as 5 mm to 30 mm, 10 mm to 30 mm, or 15 mm to 25 mm. In some implementations, the lengths of the reference electrode 110 and the counter electrode 120 are the same. In other implementations, the lengths of the reference electrode 110 and the counter electrode 120 are different.

In any of the foregoing or following aspects, the reference electrode 110 may have a thickness T that is less than the width of the reference electrode and also is ≤3 mm. In some aspects, the thickness T is ≤2 mm. In any of the foregoing or following aspects, the counter electrode 120 may have a thickness T that is less than the width of the reference electrode and also is ≤3 mm. In some aspects, the thickness T is ≤2 mm. In some aspects, the reference electrode 110 and counter electrode 120 have a thickness T within a range having endpoints selected from 0.1 mm, 0.3 mm, 0.5 mm, 0.7 mm, 1 mm, 1.5 mm, 2 mm, 2.5 mm, and 3 mm, wherein the range is inclusive of the endpoints. When the reference electrode 110 and/or the counter electrode 120 comprises a coated foil electrode (FIG. 2B), the coating 112 and/or coating 122 may have a thickness of from 1 μm to 2 mm, such as a thickness in a range having endpoints selected from 1 μm, 2 μm, 5 μm, 10 μm, 25 μm, 50 μm, 100 μm, 150 μm, 200 μm, 250 μm, 300 μm, 400 μm, 500 μm, 750 μm, 1 mm, 1.5 mm, and 2 mm, wherein the range is inclusive of the endpoints. With reference to FIG. 2B, the thickness T of the coated reference electrode 110 and/or coated counter electrode 120 is the combined thickness of the substrate foil 111, 121 and the coating 112, 122. In some implementations, the thicknesses of the reference electrode 110 and the counter electrode 120 are the same. In other implementations, the thicknesses of the reference electrode 110 and the counter electrode 120 are different.

In some aspects, the reference electrode 110 has an Rₐ≤1 μm, a width ≥0.5 mm, and a length that is greater than or equal to the width. In certain aspects, the counter electrode 120 has an Rₐ≤1 μm, a width ≥0.5 mm, and a length that is greater than or equal to the width. In any of the foregoing or following aspects, the reference electrode 110, the counter electrode 120, or both, may have a width of from 1 mm to 30 mm and a length of ≥5 mm, wherein the length is greater than or equal to the width. In some aspects, the reference electrode 110, the counter electrode 120, or both, has an Rₐ≤300 nm, a width of from 1 mm to 30 mm, and a length of ≥5 mm, wherein the length is greater than or equal to the width. In certain aspects, the reference electrode 110, the counter electrode 120, or both, has an Rₐ ≤200 nm, a width of from 1 mm to 10 mm, and a length of ≥5 mm, wherein the length is greater than or equal to the width. In certain implementations, each of the reference electrode and the counter electrode independently has a width of from 3 mm to 10 mm or 4 mm to 6 mm, such as a width of 5 mm. In certain aspects, each of the reference electrode and the counter electrode independently has a length of from 10 mm to 30 mm or from 15 mm to 25 mm, such as a width of 5 mm and a length of 20 mm.

As shown in FIGS. 1A and 1B, the reference electrode 110 and the counter electrode 120 are in a spaced-apart relationship with a void space S between adjacent edge surfaces of the reference electrode and counter electrode. In some aspects, the void space S between the electrodes 110, 120 is from 1 mm to 30 mm, as measured from adjacent edges surfaces of the reference and counter electrodes. In some implementations, the void space S is from 5 mm to 30 mm, such as from 10 mm to 20 mm.

Each of the reference electrode 110 and counter electrode 120 independently comprises a metal or a coated foil coated with a metal, and has an average surface roughness Rₐ, a width W, a length L, and a thickness T as described above. In some aspects, the metals of the reference and counter electrodes are the same, Rₐ values of the reference and counter electrodes are the same, the widths of the reference and counter electrodes are the same, the lengths of the reference and counter electrodes are the same, and the thicknesses of the reference and counter electrodes are the same.

In some implementations, a reference electrode assembly 100A, 100B includes a reference electrode 110 and a counter electrode 120, each of the reference and counter electrodes comprising a foil of a metal or a coated foil that is coated with the metal, a surface of each of the reference and counter electrodes having an average roughness Rₐ≤1 μm, each of the reference and counter electrodes having a thickness T≤3 mm, a width W of from 1 mm to 30 mm, and a length L of from 5 mm to 40 mm, wherein the length is greater than or equal the width. The metal comprises a hydrogen evolution reaction electrocatalyst. The reference electrode assembly further comprises a variable resistor 130. The reference electrode 110 and the counter electrode 120 are in a spaced-apart relationship with a void space S between the reference electrode and the counter electrode of from 1 mm to 30 mm, as measured from adjacent edge surfaces of the counter and reference electrodes. The reference electrode 110 is configured to be electrically coupled directly or indirectly to a (−) power terminal of an external power source 140. The counter electrode 120 is configured to be electrically coupled directly or indirectly to a (+) power terminal of the external power source 140. The variable resistor 130 comprises a first terminal 131 that is electrically coupled to the reference electrode 110 or the counter electrode 120, and a second terminal 132 that is configured to be electrically coupled to a power terminal of the external power source 140.

In any of the foregoing or following aspects, the variable resistor 130 may have a maximum resistance of 10 MΩ, such as a maximum resistance of 5 MΩ or 1 M. In some aspects, the variable resistor 130 has a resistance of from 10 kΩ to 10 MΩ, such as a resistance within a range having endpoints selected from 10 kΩ, 50 kΩ, 100 kΩ, 500 kΩ, 1 MΩ, 2.5 MΩ, 5 MΩ, 7.5 MΩ or 10 MΩ, wherein the range is inclusive of the endpoints.

In any of the foregoing or following aspects, the reference electrode 110 and counter electrode 120 are configured to be electrically coupled or indirectly coupled to an external power source 140, as previously described. Any suitable external power source may be used. In some examples, the external power source 140 is a battery, such as a 9V battery. In one arrangement, the reference electrode 110 is electrically coupled directly to a (−) power terminal of the external power source 140, and the counter electrode 120 is electrically coupled indirectly to a (+) power terminal of the external power source 140 (FIG. 1A). In such an arrangement, the counter electrode 120 is electrically coupled to a first terminal 131 of the variable resistor 130, and the second terminal 132 of the variable resistor 130 is coupled to the (+) power terminal of the external power source 140 (FIG. 1A). In an independent arrangement, the counter electrode 120 is electrically coupled directly to the (+) power terminal of the external power source 140, and , the reference electrode 110 is electrically coupled indirectly to the (−) power terminal of the external power source 140 (FIG. 1B). In such an arrangement, the reference electrode 110 is electrically coupled to a first terminal 131 of the variable resistor 130, and the second terminal 132 of the variable resistor 130 is coupled to the (−) power terminal of the external power source 140 (FIG. 1B).

### III. REDOX FLOW BATTERY SYSTEM

Aspects of the disclosed reference electrode assembly are useful for in situ monitoring of electrode potentials in redox flow battery (RFB) systems, such as vanadium redox flow battery (VRFB) systems, or in fuel cells or other energy storage and conversion systems. Advantageously, the reference electrode assembly allows the user to separate or decouple voltage and impedance, and allows monitoring of individual electrode potentials in the battery system, fuel cell, or other energy storage and conversion system.

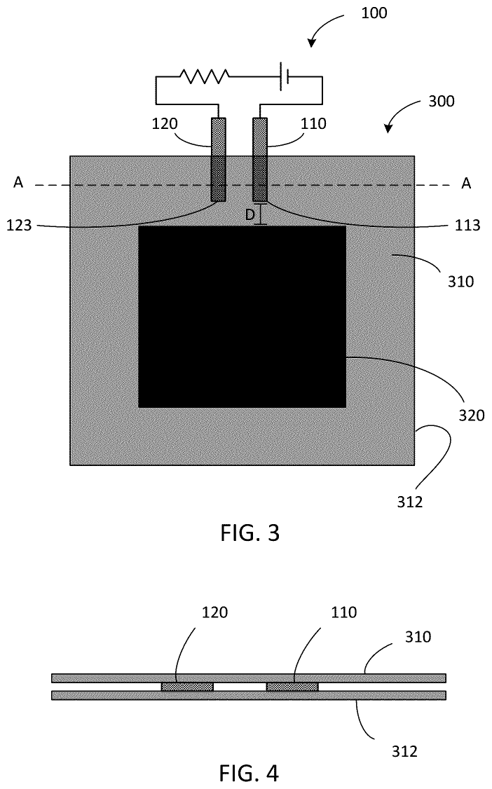

FIGS. 3 and 4 show one exemplary arrangement wherein the reference electrode assembly 100 is placed in a redox flow battery system 300. In the illustrated arrangement, the anode 320 and cathode (not shown) of the battery system 300 are positioned on either side of a separator comprising two ion-conductive membranes 310, 312. The reference electrode 110 and counter electrode 120 of the reference electrode assembly 100 are placed so that at least a portion of each electrode 110, 120 is positioned between the ion-conductive membranes 310, 312.

In any of the foregoing aspects, distal ends 113, 123 of the reference electrode 110 and counter electrode 120 are spaced apart from adjacent surfaces of the anode 320 and cathode (not shown) by a distance D of at least 2 mm. In some aspects, the distance D is at least 3 mm or at least 5 mm. In some aspects, the distance D is in a range having endpoints selected from 2 mm, 3 mm, 5 mm, 10 mm, 15 mm, 20 mm, 25 mm, 30 mm, 40 mm, 50 mm, 75 mm, or 100 mm, wherein the range is inclusive of the endpoints. In certain implementations, the distance D is 2 mm to 10 mm, such as 3 mm to 5 mm.

Conventionally, electrochemical performances of RFBs, such as VFRBs, have been evaluated in full cell mode, which makes it difficult to isolate contributions from individual electrodes and the cell degradation mechanism from each electrode challenging to identify. Some internal reference electrodes, such as single Pt wires or conventional dynamic hydrogen electrodes can decouple the cathode and anode potential drop and impedance. However, these internal reference electrodes suffer from shifting potentials during cycling of the RFB since the reference electrode is easily influenced or contaminated by the surrounding environments inside the cell such as the continuous changing of the components (concentration and valence of vanadium ion) in the electrolytes.

Advantageously, some aspects of the disclosed reference electrode assembly decouple signals from the cathode and anode and allow in-situ monitoring of individual electrodes to determine which electrode is causing performance degradation while remaining stable during long-term cycling of the battery, fuel cell, or other energy storage and conversion system. Some implementations of the disclosed reference electrode assembly provide excellent stability (as evidenced by little or no drift in potential) throughout long-term cycling, e.g., for at least 500 cycles. The enhanced stability is attributable to the greater surface area of the foil electrodes (compared to wire electrodes) and to the smooth surface of the reference electrode, which has an average roughness (Rₐ)≤1 μm.

### IV. EXAMPLES

### Methods

DHE setup: The DHE setup is illustrated in FIG. 3. Two Pt electrodes 110, 120 were inserted between two membranes of a separator in a vanadium redox flow battery comprising carbon felt electrodes. The Pt electrodes (tips) were placed approximately 5 mm from the edge of the carbon felt electrodes of the VRFB to avoid any interference by the electric field generated between the two electrodes as well as for the ease of installation. These two Pt electrodes were connected to an external electric circuit with a 9 V battery and an optimized adjustable resistor of 1 MΩ. The Pt electrode that was directly connected to the negative terminal of the 9 V battery was employed as the DHE reference electrode where the hydrogen evolution reaction (HER) occurred and the current flowing through the cell was optimized using the adjustable resistor. The distance between the two Pt electrodes (set at around 5 mm in the exemplary setup) should have a negligible effect on the results because the adjustable resistor likely can compensate for the corresponding (electrolyte) resistance change.

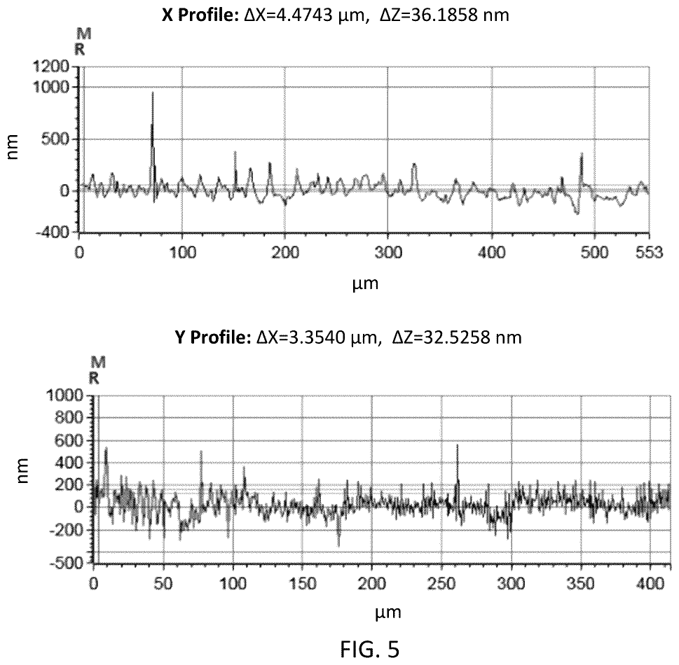

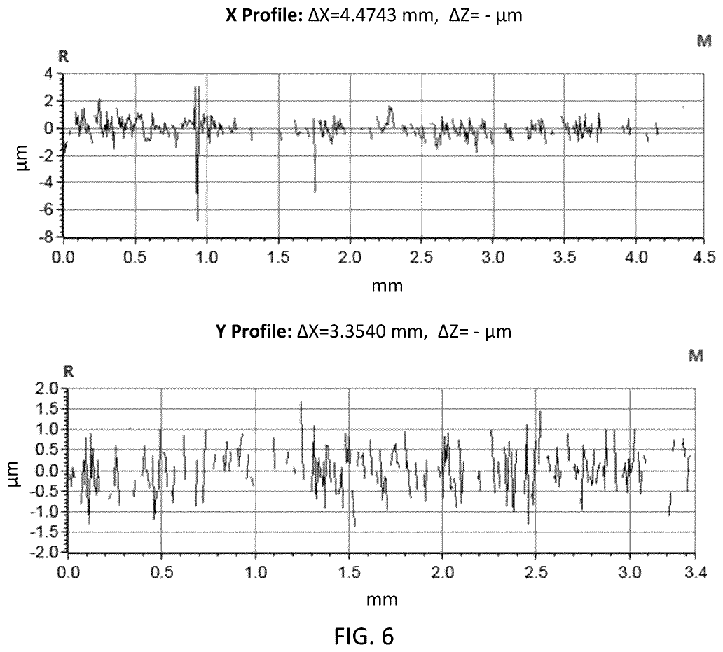

Three kinds of Pt electrodes with various shapes or surface roughness were introduced for the DHE setup: i) Pt wires (diameter 0.3 mm), ii) Pt foils with the width of 5 mm and a smooth surface (surface roughness: Ra≈100 nm), and iii) Pt foils with the width of 5 mm and a rough surface (surface roughness: Ra≈500 nm). The surface roughness (Rₐ) of the Pt foils was measured by a profilometer, and the results are shown in FIGS. 5 (smooth Pt foil, Rₐ=104.591 nm) and 6 (rough Pt foil, Rₐ=494.863 nm).

Cell fabrication with internal DHE RE and external Ag/AgCl REs: A vanadium redox flow battery (VRFB) (49 cm² active area, Standard Energy Co.) was fabricated by applying a pressure of 0.5 MPa to a stack consisting of a manifold frame, a current collector plate, a graphite bipolar plate (SIGRACET® TF6, SGL Group, Wiesbaden, Germany), a bipolar plate gasket, an internal flow frame (3 mm for thickness), a membrane gasket, a graphite felt electrode (GFD 4.6, SGL Group, 7 cm×7 cm for active area), and a Nafion® membrane (N212, Ion Power, Tyrone, PA) for each half-cell. Prior to cell assembly, the graphite electrodes were thermally treated at 400° C. in air for 6 hours to increase its hydrophilicity. The DHE based internal RE was placed between both half cells. In addition, the two external REs of Ag/AgCl (with filling solution of 4M KCl in AgCl, Pine Research Instrumentation, Durham, NC) were placed in the inlet tubing of the catholyte and anolyte respectively.

The vanadium electrolytes of 1.6 M V (V³⁺/V⁴⁺, 50/50, GfE Gesellschaft für Elektrometallurgie mbH, Nürnberg, Germany) (The GfE Vanadium Electrolyte Solution 1.6 M Online, https://www.gfe.com/02_produkte_loesungen/03_vanadium-chemikalien/PDB/Vanadium-Electrolyte-Solution-1.6-M-2012-114_V8.pdf (accessed August 2022)). were used as received. The electrolytes were pumped from the electrolyte reservoirs (Pyrex® graduated cylinders) to the flow cell compartments by using a peristaltic pump (Masterflex® L/S 7551, Cole-Parmer, Vernon Hills, IL) at a flow rate of 50 mL min⁻¹ through Viton™ tubing. The reservoirs were bubbled with nitrogen for 10 minutes and sealed before testing.

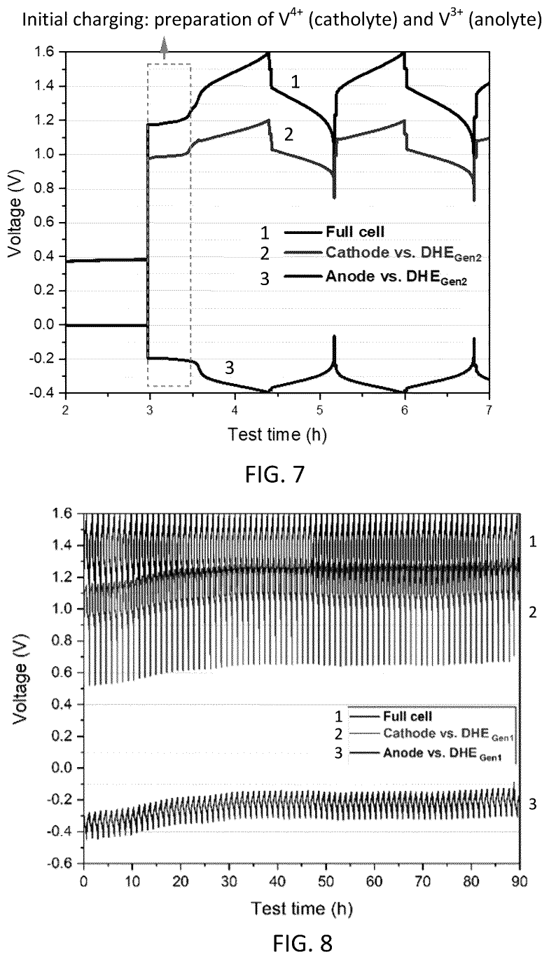

Electrochemical testing and characterization: The assembled flow cell was cycled in a charge-discharge process at room temperature with a voltage window between 1.6-0.8 V at a constant current density of 80 mA cm⁻² using an Arbin® cycler. Since the beginning electrolyte solution contained vanadium ions with a valence of 3.5 (a mixture of V³⁺/V⁴⁺, 50/50) for both catholyte and anolyte, the preparation of V⁴⁺ for catholyte and V³⁺ for anolyte was achieved by the electrochemical approach in the initial charging process of the cell, as illustrated in FIG. 7.

Polarization curves were measured in a charged cell (charged to 1.6 V and then rested for 5 minutes, with an OCV of 1.45-1.5 V). E/i-measurements were carried out from 1.45 V to 0.75 V by reducing the potential every 40 or 30 s by 0.05V (with 5 s' rest after each potential measurement). The collected data points of current (i) were the value measured over the last few seconds of each potential step.

### Example 1

### A Stable Dynamic Hydrogen Reference Electrode Assembly

### DHE Design

Long-term stability of a DHE with platinum wire electrodes (DHE_{Gen 1})was evaluated as a reference electrode in a VRFB (Huang et al. J. Electrochem. Soc. 2020, 167:160541), where the DHE_{Gen 1} demonstrated relatively stable features up to 100 cycles in an in-house designed small cell (10 cm² active area). The evaluation was extended to a commercially designed scaled cell (49 cm² active area) for practical applications, which was not successful. As shown in FIG. 8. voltage drifting of individual electrodes (cathode or anode vs. DHE_{Gen1}) was observed in the charge-discharge curves, indicating the shift of DHE potential. More specifically, the cathode voltage profile started with ˜1.1 V vs. DHE in the initial cycles indicating that the DHE potential approaches 0 V in the beginning of cycling, considering the cathode reaction of a VRFB with an equilibrium potential E° of 1.00 V vs. NHE (Equation i). Then the cathode or anode voltage (vs. DHE_{Gen1}) was increased by ca. 0.15 V that reflects the decrease of the DHE potential by ca. 0.15 V in the first 30 cycles. The DHE potential then drifted slightly up and down in the following cycles. These phenomena show the impact of cell (or electrode) size on the stability of the DHE reference electrode, which tends to be more sensitive and unstable in scaled cells (possibly including the cell design factor), probably as a result of the frequently changing chemical environment surrounding the DHE as well as the potential for non-uniform current distributions (Li et aL, Electrochem. Solid-State Lett. 2006, 9:A249).

Cathode: VO²⁺+H₂O↔VO²⁺+2H⁺e⁻ E°=1.00 V (i)

Anode: V³⁺+e−↔V²⁺ E°=−0.25 V (ii)

Full Cell: VO²⁺+V³⁺+H₂O↔VO₂_{⁺}+V²⁺+2H⁺ E°=0.25 V (iii)

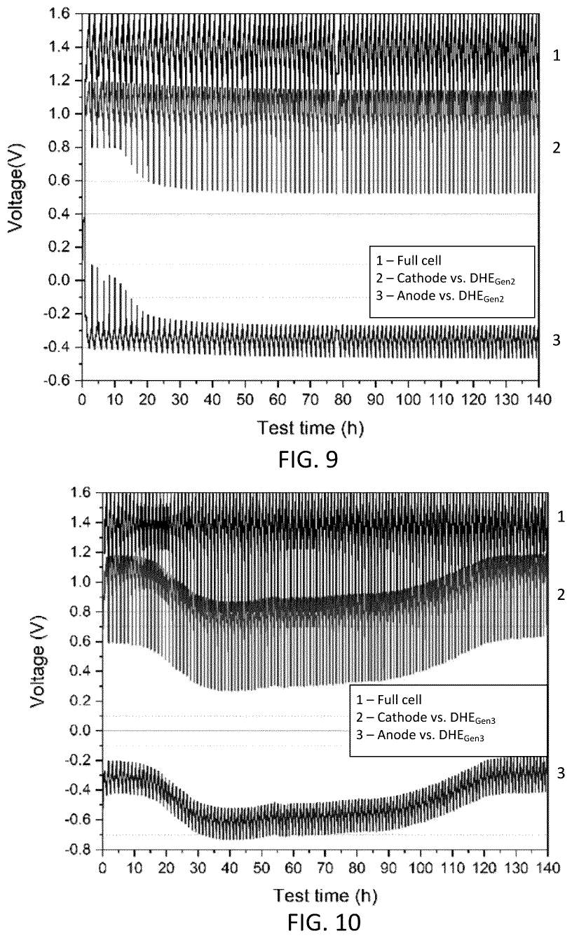

A stable and reliable DHE reference electrode relies on the consistent existence of the hydrogen evolution reaction (HER) on the Pt electrode of the DHE. To achieve greater stability and reliability, Pt foils with smooth surfaces (Ra≈100 nm, achieved by polishing or pressing) were introduced for the DHE assembly design (named DHE_{Gen2}) as shown in FIG. 1A. During the charging and discharging operation, the voltage curves of individual electrodes (vs. DHE_{Gen2}) were observed to be remarkably stable (FIG. 9), indicating that a constant potential was achieved for the DHE_{Gen2} by increasing the size of the Pt electrode. It is apparent that the charge-discharge curves of each electrode had somewhat distinct characteristics during the initial 10 cycles in which the discharge curves of the cathode and anode ended at a falling voltage as the cycling proceeded. Without wishing to be bound by a particular theory, this observation might be associated with notable changes in the open circuit voltage (OCV) and overpotential of the cathode and anode in the first few cycles. The consistent voltage of the cathode or the anode vs. DHE_{Gen2} at the top of charge demonstrated the highly stable potential of the DHE during cell cycling and this was attributed to the smooth Pt foil-based electrodes.

The effects of the surface roughness were further evaluated. A rough surface (Ra≈500 nm, achieved by using a rough sandpaper for polishing) was further introduced to the Pt foil electrodes 110, 120 (FIG. 1) to create a higher surface area of the reference (working) electrode and thereby increase the opportunities of the HER resulting in the stability improvement of DHE assembly. However, as shown in FIG. 10, the cathode or anode voltage (vs. DHE_{Gen3}) shifted significantly more, indicating that the DHE assembly with Pt foils having a rough surface was less stable than the normal Pt wires. In general, the cathode and anode voltages (vs. DHE_{Gen3}) were relatively stable in the initial 10 cycles, but their voltages dropped dramatically by ca. 0.3 V where they remained relatively stable for a prolonged period of time, and then followed by a gradual voltage increase returning to the initial value. In the initial 10 cycles or so, the cathode potential was approximately 1.1 V vs. DHE, close to the VO^{2 +}/VO₂₊ potential (E°=1.00 V, Equation i), while the anode potential was approximately −0.3 V vs. DHE, close to the V³⁺/V²⁺ potential (E°=−0.25 V, Equation ii). Over the 30^{th}-80^{th} cycles, the cathode potential decreased to 0.8 V vs. DHE, while the anode potential decreased to −0.6 V vs. DHE. After 120 cycles, both cathode and anode potential recovered to 0.8 V and −0.6 V vs. DHE. This phenomenon indicated that the potential of the DHE approached 0 V during the initial cycles, climbed progressively to 0.3 V, and then returned to 0 V.

As reported, there is co-existence of H⁺ and vanadium species in the electrolyte (nearby Pt electrodes), thus the competition of HER and vanadium redox reaction occurs on the DHE.

2H⁺+2e⁻→H₂ E°=0.00 V (iv)

VO²⁺+2H⁺+e⁻→V³⁺+H₂O E°=0.34 V (v)

According to Equations (iv) and (v), the DHE potential shifts from 0 V to around 0.3 V which indicates the competition between HER and vanadium redox reaction at the DHE; these two reactions switched with each other, leading to a dramatically changed DHE potential. The high surface area of the Pt foil working electrode in DHE_{Gen3} accelerated the competition between HER and the vanadium redox reaction.

The results indicate that the high stability of the DHE reference electrode in a scaled cell can be achieved by optimizing the DHE design of tuning the size (area) and surface roughness of the Pt electrodes. The increase in the area of Pt electrode will benefit a stable HER and an improved stability of the DHE while a further increase in the surface area of the Pt electrode facilitates the competition of HER with other reactions inside the cell such as the vanadium redox reaction. The demonstrated highly stable DHE_{Gen2} with an optimized design (based on Pt foils with a smooth surface) will serve as the reference electrode in the subsequent study.

### Internal DHE Reference Electrode vs. External Ag/AgCl Reference Electrode

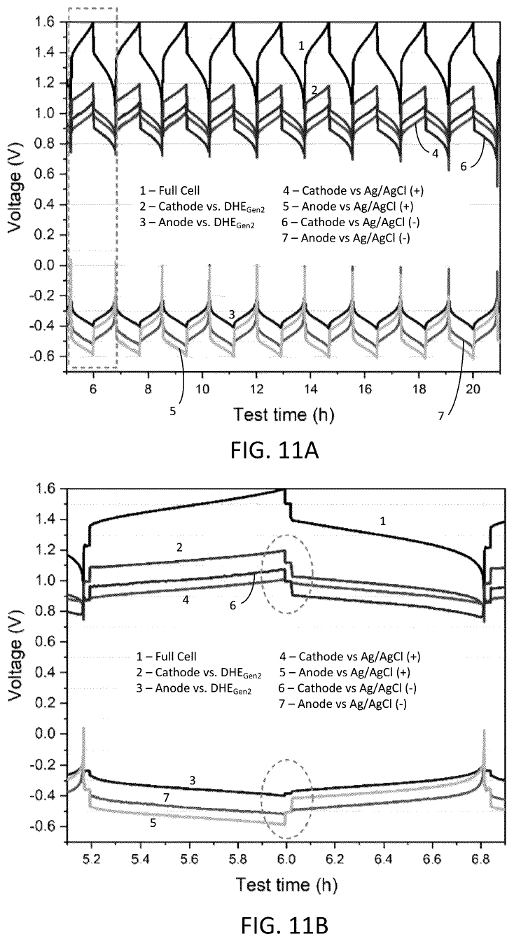

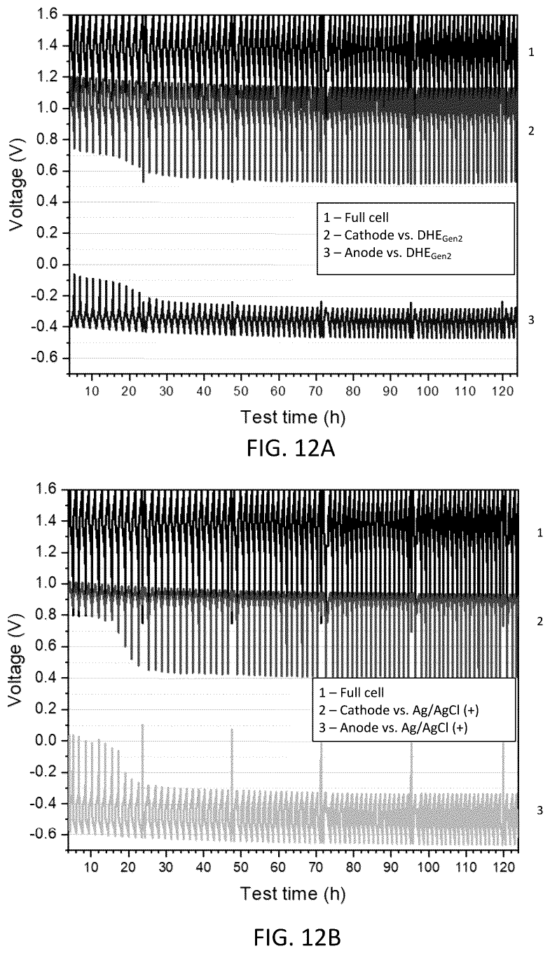

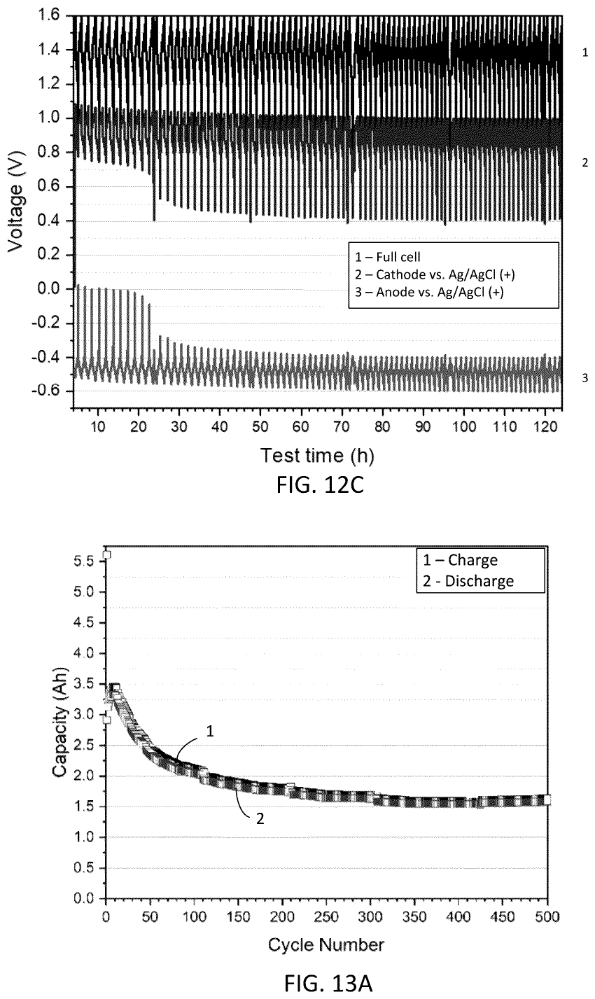

To further validate the accuracy and stability of the newly developed DHE assembly in the scaled cell, two Ag/AgCl REs were placed in the inlet tubing of the catholyte and anolyte respectively (named as Ag/AgCl (+) and Ag/AgCl (−)), while the DHE assembly was sandwiched between two membranes separating the half cells, as described above in Methods. The Ag/AgCl REs were used as external reference electrodes for in-situ monitoring of the potential in comparison with the internal DHE reference electrode. As shown in FIGS. 11A-11B and FIGS. 12A-12C, the charge and discharge voltage profiles of individual electrodes (either vs. the internal DHE RE or the external Ag/AgCl REs) present the extremely consistent curves without drifting for the initial cycles (FIGS. 11A-11B) and for long-term cycling (FIGS. 12A-12C). The consistency of the cathode or anode voltage curve vs. different REs include the discharge curves shifting (i.e., the cathode and anode curves ended at a decreasing voltage) in the initial 10 cycles and the slight decrease in the cathode or anode voltage at the top of charge especially for the initial 50 cycles (by around 50 mV). These consistent curves further demonstrate the high stability of the newly developed DHE in a scaled VRFB.

The cathode (or anode) voltage curves vs. different REs (DHE_{Gen2}, Ag/AgCl (+), and Ag/AgCl (−)) show the same pattern and are almost parallel to each other. The gaps among the three voltage curves of each individual electrode (vs. three REs) includes the differences in: (a) the potential of REs (between DHE and Ag/AgCl electrodes), and (b) the overpotential from the membrane since these REs are placed in different positions of the flow cell.

The difference in the potential of the REs can be determined by the difference in the OCV of the individual electrode (cathode or anode) vs. different REs. As specified in the dashed circles in FIG. 11B, the open-circuit voltage (OCV) of the cathode (or anode) vs. external Ag/AgCl REs (at the state of rest) showed the same value, which is 1.00 V (or −0.51 V) while the OCV of cathode (or anode) vs. DHE RE is 1.12 V (or −0.39 V), resulting in 0.12V for the difference in the potential of Ag/AgCl and DHE reference

electrodes. The potential of Ag/AgCl (4 M KCl) is known as 0.199 V_{vs. NHE} at 25° C. [32]. Therefore, the potential of the DHE is around 79 mV_{vs. NHE} at 25° C., as shown in Equations (vi)-(viii).

E_{Ag/AgCl (4 M KCl)}−E_{DHE}=0.12 V (vi)

E Ag/AgCl (4 M KCl)=0.199 V vs. NHE at 25° C. (vii)

E DHE=0.079 V vs. NHE at 25° C. (viii)

The hydrogen standard electrode potential (E°) is 0 V, thus the potential of the DHE in our cell (79 mV) probably reflects the internal environment of the cell such as the activity of the hydrogen ions (a _{H+}) and the partial pressure of the hydrogen gas (p_{H2}) surrounding the Pt electrodes of the DHE. This behavior can be explained according to the Nernst equation (ix).

$$E = {E}^{0} - \frac{RT}{zF} ln Q = \frac{RT}{F} ln \frac{{a}_{{H}^{+}}}{\sqrt{{p}_{H 2} / {p}^{0}}} \qquad ( ix )$$

The Donnan potential (due to the proton concentration differences across the membrane) was included in a more accurate form of the Nernst equation for a VRFB (Knehr et al., Electrochem. Commun. 2011, 13:342). Here the two Pt electrodes in the DHE were on the same side of the membrane. As a result, the Donnan effect was not included in DHE's potential. However, when the potential of DHE (between two membranes) was compared with that of Ag/AgCl REs (in the inlet of the catholyte and anolyte), the Donnan effect may need to be taken into account for the potential comparison in Equation (vi) and (viii) since DHE and Ag/AgCl REs are on different sides of the membrane.

Since the DHE and the two Ag/AgCl REs are assembled in different positions of the cell (for example, between the membranes and in the inlet tubing of the catholyte or anolyte), the measured voltage of the individual electrode vs. the three REs during charging or discharging includes the overpotentials from the membrane. Since DHE was introduced between the two membranes, the electrode voltage vs. DHE contains the overpotential effect from one layer of the N212 membrane. Depending on the relative positions of the electrode and external Ag/AgCl RE, the electrode voltage vs. Ag/AgCl RE includes or excludes the overpotential effect from two layers of the membrane. For instance, the cathode (or anode) voltage vs. the RE placed in the inlet of catholyte (or anolyte) will not include the overpotential from the membrane, whereas the cathode (or anode) voltage versus the RE placed in the inlet of anolyte (or catholyte) will include the effect of the two layers of membranes. Despite the gaps between the voltage curves of each individual electrode, the consistent pattern of the curves for each electrode demonstrates the remarkable stability of the newly developed DHE in a scaled VRFB.

### Example 2

### Reliability and Degradation of a Scaled VRFB Determined by DHE Reference Electrode Assembly

### Cell Performance Over Long-Term Cycling

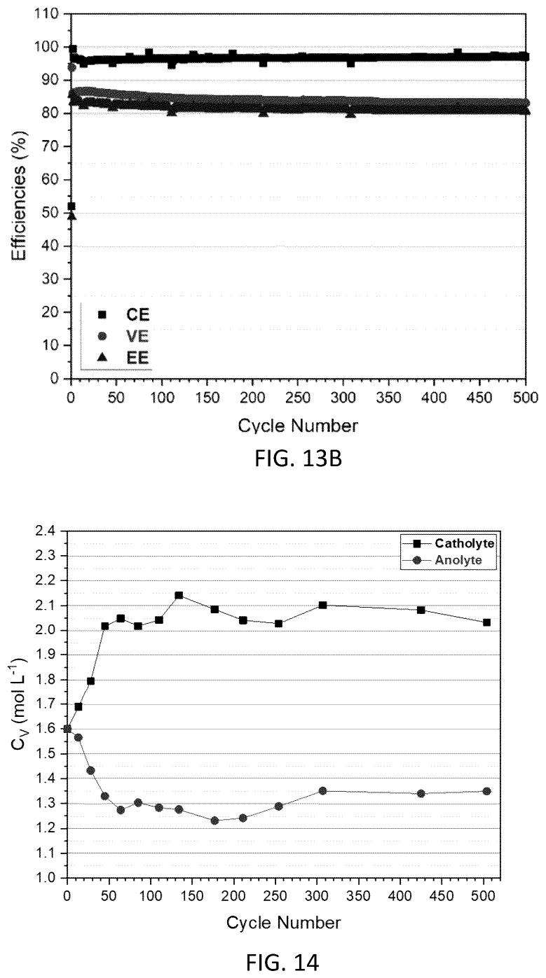

With the developed DHE reference electrode assembly of Example 1, the reliability and degradation mechanism of a scaled VRFB were investigated. The long-term cycling performance of the scaled cell using 1.6 M vanadium (GfE) electrolyte with two Nafion® N212 membranes is shown in FIGS. 13A and 13B. A DHE based internal reference electrode assembly was inserted into the cell (between two membranes separating the half cells) and two Ag/AgCl based external reference electrodes (in the inlet of catholyte and anolyte respectively).

As shown in FIG. 13A, the charge and discharge capacity continuously increased from 3.17 and 3.15 Ah in the 2^{nd} cycle to 3.32 and 3.20 Ah in the 9^{th} cycle respectively. This increase may be associated with a decrease in the overpotential of the cell in the initial cycles. The charge and discharge capacity decreased sharply to 2.32 and 2.24 Ah in the 100^{th} cycle followed by a slight decrease and appeared to be stable for the following 400 cycles; the capacity reached 1.84 and 1.80 Ah in the 500^{th} cycle. The discharge capacity retention was ca. 57.1% for a total of 500 cycles in which the average decrease rate of discharge capacity was 9.1 mAh per cycle for the initial 100 cycles and 1.1 mAh per cycle for the following 400 cycles. The more significant capacity fade observed in the initial 100 cycles is mostly associated with the imbalanced vanadium active species between the positive and negative half-cells that is induced by electrolyte (i.e., vanadium ion) crossover (Luo et al., ChemSusChem 2013, 6:268). As indicated in FIG. 14, the total concentration of vanadium ions in the catholyte and anolyte (measured by ICP) kept changing, particularly during the initial 100 cycles where the total V concentration increased on the positive side and decreased on the negative side. The negative-to-positive transfer of vanadium ions (as well as water) during cycling is validated and in good agreement with a previous study (Ibid.). Once the concentration gap between the catholyte and anolyte reached the maximum at around 100 cycles, it remained constant during the following 400 cycles, and the discharge capacity faded due to the (vanadium ions) crossover being less significant.

Compared with the capacity, the efficiencies (CE-Coulombic efficiency, VE-voltage efficiency, and EE-energy efficiency) in FIG. 13B exhibited much higher retentions of 97.6, 96.6, and 94.3% for the CE, VE and EE, respectively. The low CE in the first cycle (51.9%) was due to the beginning electrolyte solution containing vanadium ions with a valence of 3.5 (a mixture of V³⁺/V⁴⁺, 50/50) for both catholyte and anolyte. As a result, the preparation of V⁴⁺ for catholyte and V³⁺ for anolyte was part of the initial charging process, leading to the low CE in the first cycle. The high CE (99.4%) in the second cycle could indicate that the system was still adjusting after the first cycle. After that the CE decreased slightly from 96.9% (in the 3^{rd} cycle) to 96.2% (in the 10^{th} cycle) and then increased gradually (to 96.5%) in the following 100 cycles. On the contrary, the VE increased slightly (from 86.0 to 86.5%) in the initial 10 cycles and then decreased gradually (to 84.8%) in the following 100 cycles. Both the CE and VE were relatively stable in the following 400 cycles, reaching 97.1 and 83.1% in the 500^{th} cycle, respectively. The trends of CE and VE made the final EE decrease slightly in the initial 100 cycles (from 83.5% in the 3^{rd} cycle to 81.8% in the 100^{th} cycle) and then remained stable up to 500 cycles (80.6%). The crossover is assumed to be a primary factor to the considerable capacity fading and efficiency shifting in the first 100 cycles (Ibid.). As the crossover becomes less significant after 100 cycles (indicated by vanadium ion concentration of catholyte and anolyte vs. cycles in FIG. 14), both capacity and efficiencies appeared to be relatively steady. Without wishing to be bound by a particular theory, the capacity increase and efficiency shift observed in the initial 10 cycles (slight decrease and increase in CE and VE, respectively, accompanied by sharp drop in overpotential) might be also linked to the electrode activation process.

### Charge-Discharge Voltage Profiles Over Long-Term Cycling: Full Cell and Individual Electrodes

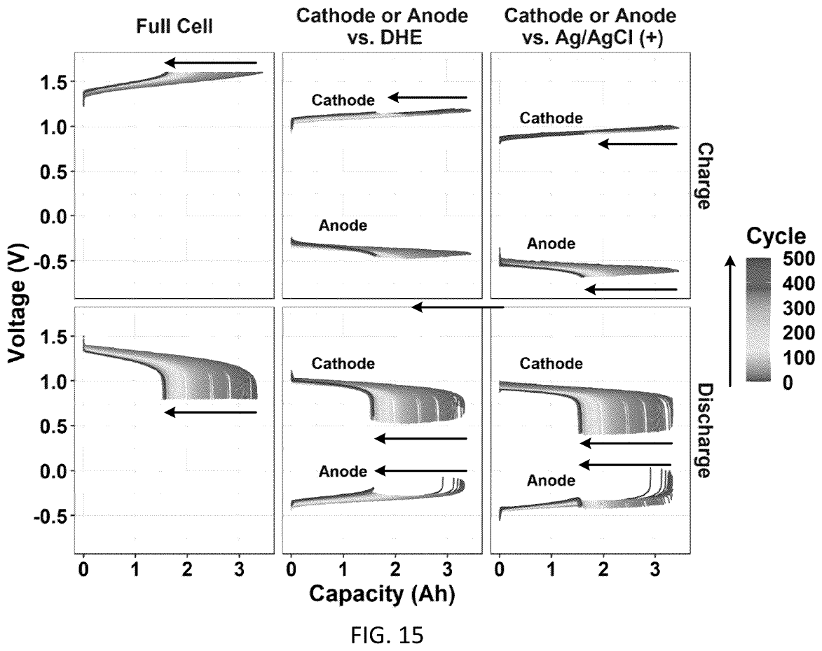

The charge-discharge voltage profile of a VRFB during cycling and shown in FIG. 15 demonstrate that the capacity fade is associated with the continuous increase in the overpotential of the cell. This is indicated by the steadily ascending charge curves and descending discharge curves with continuous cycling. The overpotential increased dramatically in the initial 100 cycles (FIG. 15, left panels), followed by a slight increase and then relatively stable until 500 cycles. The increasing overpotential trend was in good agreement with the capacity fading and decrease in VE that appeared more significant in the initial 100 cycles and remained stable afterwards. The degraded performance associated with the increasing cell polarization might be attributed to the increase in concentration polarization induced by significant crossover (Ibid.) as mentioned earlier.

During the charge process, the cathode curves vs. DHE remained relatively consistent while the anode curves vs. DHE decreased by ˜0.05 V with cycling especially for the initial 100 cycles as shown in FIG. 15 (upper middle panel). This trend aligns well with the behavior of the full cell in which the charge voltage rose by around 0.05 V in the initial 100 cycles. The phenomenon indicates that the performance degradation (overpotential increase) during charging of the cell is dominated by the anode. The shifting of the individual electrode voltages vs. Ag/AgCl (+) RE in FIG. 15 (upper right panel) showed a similar trend when compared with the corresponding curves vs. DHE. This indicates that the influence of the membrane on the cell degradation upon charging was negligible.

During the discharge process, the voltage curve of the full cell decreased gradually by 0.05 V for the initial 100 cycles and by 0.03 V for the following 400 cycles (FIG. 15, lower left panel), in which the cathode curve vs. DHE decreased by 0.05 V (for the initial 100 cycles) and increased slightly afterwards while the anode curve vs. DHE increased slightly in the initial 100 cycles and then more significantly (by 0.05 V) until 500 cycles (FIG. 15, lower middle panel). It can be deduced that the performance degradation during discharge is mostly derived from the cathode contribution in the initial 100 cycles but dominated by the anode in the following 400 cycles. The discharge curves for the individual electrode voltage vs. external RE Ag/AgCl (+) showed a somewhat different shifting trend in FIG. 15 (lower right panel), indicating a contribution from the membrane. The cathode curve vs. Ag/AgCl (+) decreased more significantly than that vs. DHE. The cathode curve vs. DHE includes the overpotential from one layer of the membrane but the one vs. Ag/AgCl (+) excludes the membrane effect, which suggests that the membrane plays a role in decreasing the overpotential of the discharge process. This effect was also validated by the anode curves during discharge. The anode curve vs. DHE (including one-layer of membrane) in FIG. 15 (lower middle panel) showed a more significant overpotential increase than that vs. Ag/AgCl (+) (including the two-layer of membrane effect).

In summary, the anode was primarily responsible for capacity fading (overpotential increase) during both the charge and discharge processes throughout 500 cycles except for the first 100 cycles of discharging where the cathode contributed more. In a prior work (Huang et aL, J. Electrochem. Soc. 2020, 167:160541) conducted in a smaller flow cell (almost ⅕ the active size of the scaled cell) with a different cell design, electrolyte composition (vanadium and acid concentration), and flow rate, it was observed that the cathode acted more dominantly for cell degradation. Several parameters, such as the size and design of the flow cell, cell components (electrolyte composition, electrode, and membrane), flow rate, and testing conditions, may influence the degradation mechanism of a VRFB, according to these studies. Embodiments of the disclosed reference cell assembly may be used further investgate the degradation mechanisms in various VRFBs.

### OC Vs and Overpotentials at the Top of Charge and Bottom of Discharge: Full Cell and Individual Electrodes

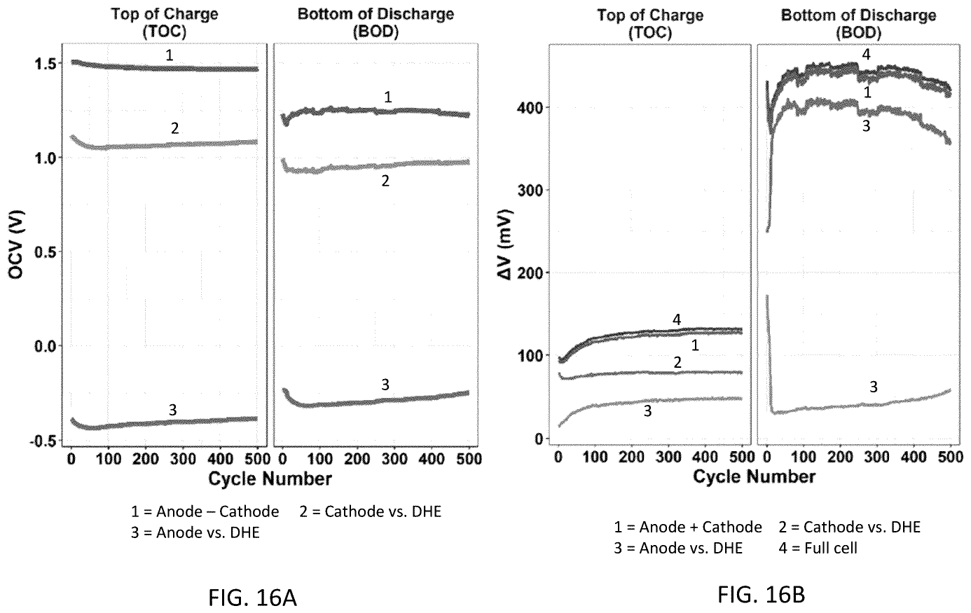

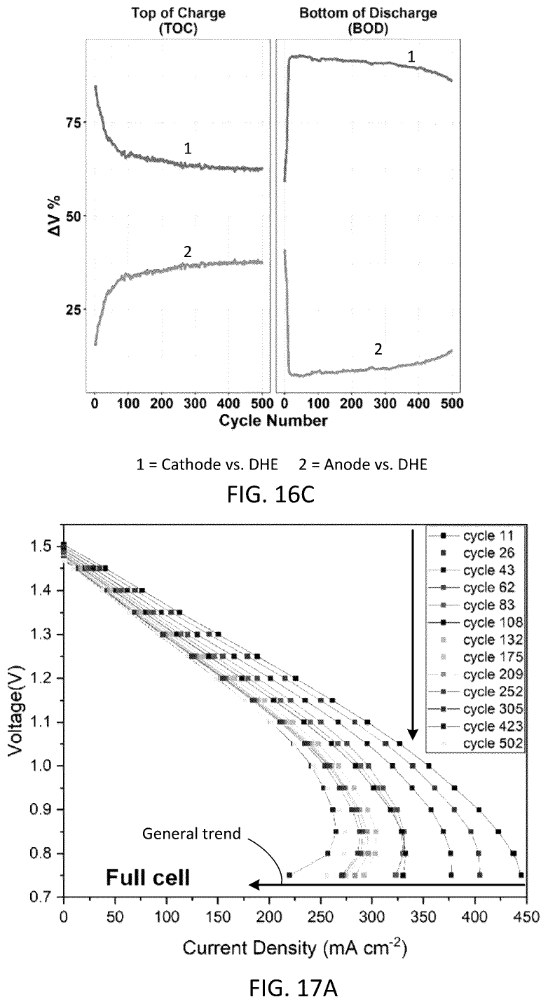

OCV and the overpotential (ΔV) at the top of charge (TOC) and the bottom of discharge (BOD) as key metrics for the reliability/degradation features of a redox flow battery were determined for our scaled VRFB and its individual electrodes (by using the disclosed DHE assembly as RE) up to 500 cycles (FIGS. 16A-16C). FIG. 16A shows the OCV at the TOC and BOD as a function of cycle numbers for the full cell, individual electrodes (cathode or anode vs. DHE), and the difference of individual electrodes (cathod−anode). Note that curve #4 of FIG. 16B (full cell) is overlapped by curve #1 (Anode+Cathode), indicating the high accurate and stability of DHE since the theoretical value (Anode+Cathode) agreed well with the actual value (full cell) over 500 cycles.

The OCV of the full cell decreased gradually at the TOC and increased at the BOD in the initial ˜100 cycles (excluding the first 10 cycles) and then tended to be relatively stable. As a strong indicator of the state of charge (SOC) of a VRFB (Mohamed et aL, Elektron. Eletrotech. 2013, 19:37), the OCV has an immediate relationship with the concentration of active materials (vanadium ions) in the catholyte and anolyte. The observed shift of OCV agreed well with the changes of vanadium ion concentration in the catholyte and anolyte due to the crossover of vanadium ion, as shown in FIG. 14 and discussed earlier. The results indicated that in the cell system, the crossover induced cell performance degradation mostly occurred in the first 100 cycles.

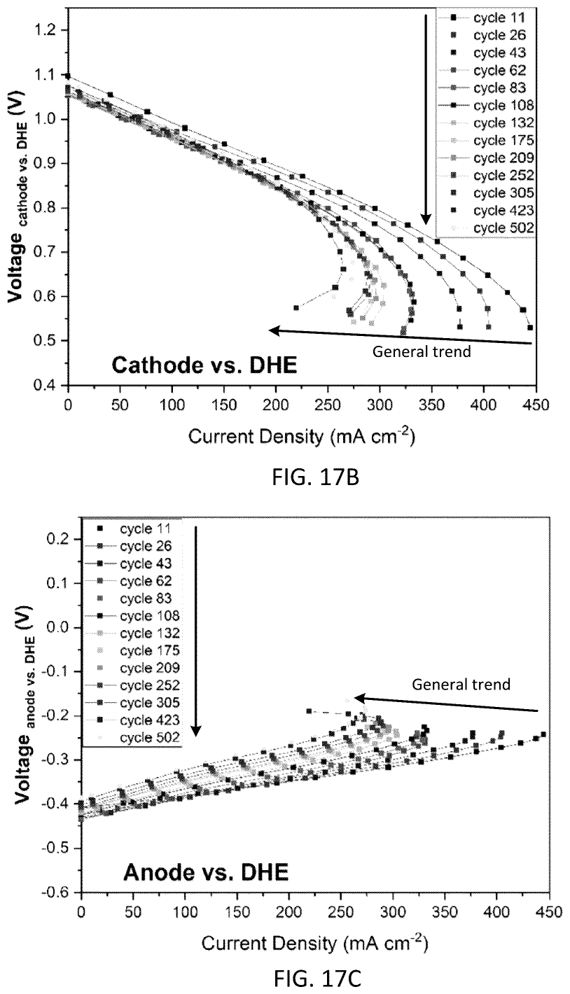

The OCV of the cathode and anode (vs. DHE) showed a similar trend that decreased in the initial 80-100 cycles and then increased gradually until 500 cycles. Considering the reverse feature of the cathode and anode (V_{Full cell}=V_{Cathode}−V_{Anode}), the consistent OCV curves of individual electrodes indicated the opposite roles of the cathode and anode in contributing to the overall degradation. The details will be further discussed in the overpotential (FIGS. 16B, 16C) and polarization curve measurements (FIGS. 17A-17C).

FIG. 16B shows the overpotentials at the TOC and BOD as a function of cycle numbers for the full cell, individual electrodes (cathode or anode vs. DHE), and the sum of individual electrodes (cathode+anode). The overpotential was the difference (absolute value) between the voltage at the operation current of 80 mA cm⁻² (the last point of recorded voltage in the charge or discharge step) and the OCV (the recorded voltage at the 1.5 mins of rest step after the charge or discharge step). In general, the overpotentials of the full cell at the BOD (400-450 mV) were ˜3 times higher than those at the TOC (100-130 mV), which was mostly dominated by the cathode. Aligned well with those of the full cell, the overpotentials of cathode at the BOD (350-400 mV) were ˜3 times higher than at the TOC (75-80 mV), whereas the overpotentials of anode were kept stable and in a relatively lower value (20-50 mV) at both BOD and TOC (except for the initial 10 cycles).

In general, the largest change in the overpotential during cycling was observed in the initial 100 cycles for the full cell and the individual electrodes. This trend of an initial decrease (in the first 10 cycles) followed by an increase (until 100 cycles) was observed in the overpotentials of full cell at both the TOC and BOD; the trend was more significant at the BOD in comparison to the TOC. For the initial 10 cycles, the slight decrease in the overpotential at the TOC was mostly dominated by the cathode whereas the sharp decrease at the BOD was dominated by the anode. The increase in the overpotential between the 10^{th} and 100^{th} cycles of the full cell was mostly caused by the anode at the TOC and by the cathode at the BOD. The results indicated that the individual electrodes showed quite different behavior in the overpotentials between the TOC and BOD. In addition, at the TOC or BOD, the cathode and anode contributed to the overpotential in an opposite way which is clearly indicated by the relative proportion of overpotentials for individual electrodes in FIG. 16C. This also aligned well with the OCV measurement discussed earlier. At the TOC, the largest difference in overpotentials between cathode and anode existed in the 1^{st} cycle, with ˜85% and 15% ΔV for cathode and anode, respectively, as shown in FIG. 16C. The difference was dramatically decreased in the following 100 cycles, and then shifted slightly and remained relatively stable, leading to the smallest difference (˜62% and 38% ΔV for cathode and anode, respectively) near the end of 500 cycles. On the contrary, the smallest difference in overpotential (60% and 40% ΔV for cathode and anode) at the BOD was observed in the 1^{st} cycle, and then the overpotentials of the cathode (up) and anode (down) went in the opposite direction sharply during the next 10 cycles and then reached the largest difference (88% and 12% ΔV for cathode and anode, respectively). The overpotentials then became stable with the difference becoming gradually smaller, particularly after 300 cycles.

It is known that the overpotential at the TOC or BOD plays a significant role in dominating the charge or discharge capacity of a VRFB (Choi et al., Electrochim. Acta 2016, 213:490; Huang et aL, J. Electrochem. Soc. 2020, 167:160541), which has been verified in the present study where the shifting trend of overpotential during long-term cycling corresponded well with the capacity fading trend—the smaller overpotential, the higher capacity, and vice versa. It is noticeable that the charge and discharge capacity increase in the first 10 cycles of FIG. 13A is mostly attributed to the initial decrease in the overpotential of the full cell (dominated by the cathode at the TOC and anode at the BOD), as shown in FIG. 16B.

In summary, the cathode showed a much higher overpotential than the anode at both the TOC and BOD up to 500 cycles which indicates that the cathode reaction played a more significant role than the anode reaction in limiting the capacity particularly in the discharge process. However, the cell degradation had an overall larger contribution from the anode; the anode overpotential increased gradually during long-term cycling whereas the cathode showed the opposite contribution except for the initial 50 cycles where the cathode dominated at the BOD.

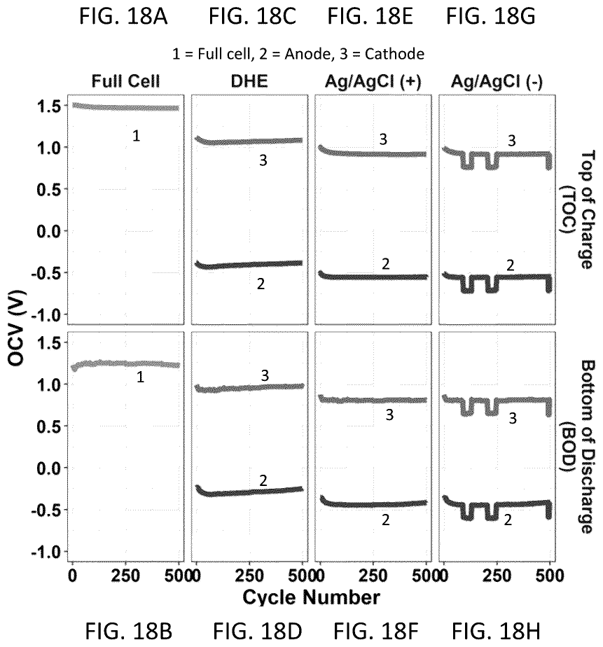

In addition, the difference in OCV between the cathode and anode (Cathode−Anode), and the sum of the overpotentials of the cathode and anode (Cathode+Anode) are plotted in FIGS. 16A-16B for both TOC and BOD. All curves aligned well with their corresponding full cell curves, which validates high accuracy and long-term stability of the DHE assembly throughout 500 cycles. To further compare the internal DHE RE with the external Ag/AgCl REs, the OCV of full cell and individual electrodes vs. different REs at the TOC and BOD are plotted in FIGS. 18A-18H. With different REs, the OCV curves of each electrode still showed a consistent trend at the TOC or BOD over 500 cycles. The gap in the OCV value reflected the difference in the potential of REs (see Equation vi) as mentioned earlier and was consistent during 500 cycles. All these again validate the long-term stability of the DHE. Unstable OCV curves of electrodes vs. Ag/AgCl (−) were observed in FIGS. 18G-18H, indicating the unstable potential of Ag/AgCl (−) RE likely caused by bubbles blocking the tubing of anolyte starting at the ˜80^{th} cycle. The behavior of the Ag/AgCl (−) RE returned to normal once the bubbles were removed, but the issue appeared again from the 200^{th} cycle. The new DHE has a substantial advantage over the Ag/AgCl RE in terms of the stability of the potential during long-term cycling due to the reduced influence of gas generation, which should be accounted for in the external Ag/AgCl RE approach.

### Polarization Curve Measurement: Full Cell and Individual Electrodes

Polarization curve measurements are commonly used to analyze the performance behavior/losses in redox flow batteries and fuel cells. The primary losses identified in a VRFB via analysis of polarization curves include i) kinetic activation polarization, ii) ohmic polarization (iR losses), and iii) mass transport limitation, which are assigned to the three regions from low to high current density in a generalized polarization curve (Aaron et al., J. Appl. Electrochem. 2011, 41:1175). The polarization curves for the full cell and individual electrodes (cathode or anode vs. DHE) after charging to 1.6 V were measured at different cycles, as shown in FIGS. 17A-17C. All the curves present two typical regions of ohmic loss and transport loss, without the region of activation loss when compared with the generalized polarization curve of a VRFB (see FIG. 2 in Aaron et al., J. Appl. Electrochem. 2011, 41:1175). The y-intercepts where the current density is zero of the curves are the OCVs at the TOC. As shown in FIG. 17A, the notable decrease in OCV of the full cell was observed from the 11^{th} to the 108^{th} cycle (also see FIG. 16A at the TOC). Moreover, the increase in both the ohmic loss (indicated by the increase in the slopes of the polarization curves at medium current density) and the transport loss (indicated by the occurrence of mass transport limitation at lower current densities) were observed in the initial 100 cycles where the most significant degradation of the cell was indicated. After 100 cycles, the degradation became less significant. The OCV remained relatively stable and only a small change was observed at low and medium current density in the polarization curves; the mass transport limitation occurred at similar current densities. The mass transport limit occurred at ˜290 and 270 mA cm⁻² at the 132^{nd} and 502^{nd} cycles respectively.

The polarization curves for the cathode (vs. DHE) in FIG. 17B showed a significant decrease in OCV from 11^{th} to 62^{nd} cycles, and then the OCV remained relatively stable with a partial recovery during the remaining 400+cycles. The change of ohmic loss was unobvious over 500 cycles, as indicated by the parallel feature of these curves at the current density below 200 mA cm⁻². Similar to the full cell, a significant change in mass transport was observed in the first 100 cycles, after that, mass transport change became less significant. Due to the reverse features of the anode when compared with those of the cathode (such as the voltage, V_{Full cell}=V_{Cathode}−V_{Anode}), it showed quite different polarization curves as shown in FIG. 17C. A significant increase in the OCV of the anode was observed after 100 cycles which indicates that the anode showed more degradation during long-term cycling. The ohmic loss increased slightly in the initial 100 cycles and then remained relatively constant. By further calculating the slope of the linear region in the polarization curves (FIGS. 17B, 17C), it was found that the ohmic resistance of the cathode was much larger than that of anode which indicates that the ohmic loss of the full cell was mainly dominated by the cathode in the whole 500 cycles. In addition, a significant increase in the transport loss of anode was observed in the initial 100 cycles, which is in good agreement with those trends in the full cell and cathode.

In general, the performance loss of the cell increased more significantly in the initial 100 cycles and then remained relatively stable up to 500 cycles. In terms of OCV (or overpotential at the TOC), the cell degradation was initially caused by the cathode but had a larger contribution from the anode up to 500 cycles. The ohmic loss of the full cell was mostly dominated by the cathode with insignificant changes throughout 500 cycles, but the initial slight increase in the ohmic loss was more induced by the anode. The mass transport loss, which showed a significant increase in the initial 100 cycles, was contributed by both the cathode and anode.

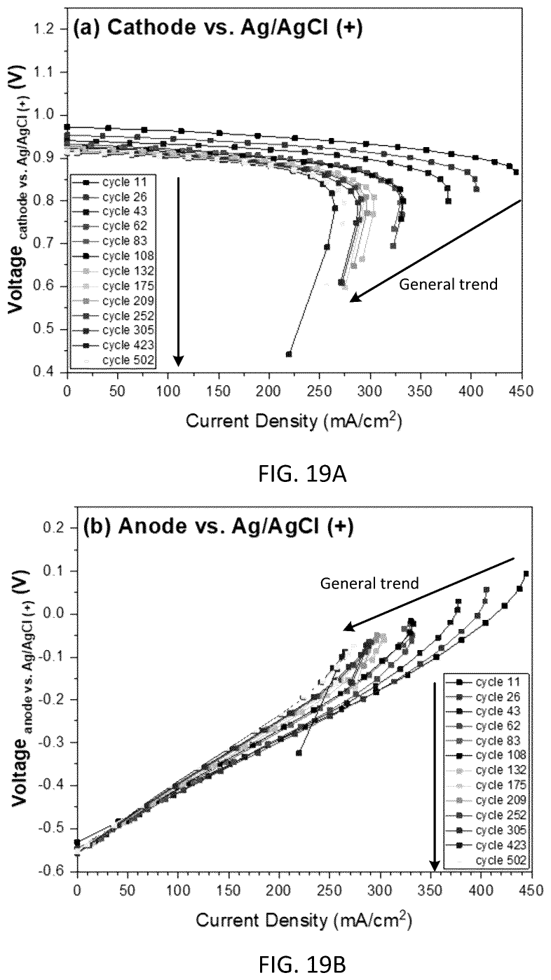

Lastly, the polarization curves of the cathode and anode vs. Ag/AgCl (+), shown in FIGS. 19A and 19B, reflect the contribution from the membrane when compared with those of the cathode and anode vs. DHE (FIGS. 17B, 17C). The cathode curves vs. Ag/AgCl (+) tend to more horizonal in direction (compared with FIG. 17B), indicating the lower ohmic loss due to the subtraction of the membrane contribution, while the anode curves vs. Ag/AgCl (+) present a steeper direction (compared with FIG. 17C), indicating the higher ohmic loss due to double layer membrane contribution.

Conclusions: The development of a stable reference electrode is important for RFB reliability and degradation investigation. In this study, a reference electrode assembly based on DHE with a novel design on the area and surface roughness of foil electrodes (e.g., Pt foil) was developed for a scaled all-vanadium redox flow battery. The newly developed reference electrode assembly demonstrated a recorded high accuracy and long-term stability up to 500 cycles in a scaled vanadium RFB. By integrating the stable RE assembly approach to decouple the cathode and anode in conjunction with voltage profiles, overpotentials, and polarization curve measurements, the degradation mechanism of a scaled vanadium RFB was further investigated. The performance fading (capacity and efficiencies) and losses (ohmic and transport loss) were found to occur dramatically in the initial 100 cycles, due to the increase in cell polarization caused by electrolyte (vanadium ion) crossover. Relatively, the anode contributed more to overall cell degradation over long-term cycling, whereas the cathode reaction played a far more significant role than the anode response In limiting the capacity especially during discharge. In addition, the effect of the membrane on overpotential and performance losses was preliminarily evaluated by comparing individual electrodes to reference electrodes (DHE and Ag/AgCl) situated in various positions across the cell.

In view of the many possible embodiments to which the principles of the disclosure may be applied, it should be recognized that the illustrated embodiments are only preferred examples of the disclosure and should not be taken as limiting the scope of the disclosure. Rather, the scope of the invention is defined by the following claims. We therefore claim as our invention all that comes within the scope and spirit of these claims.

We claim:

1. A reference electrode assembly, comprising:
a reference electrode comprising a foil of a first metal or a coated foil that is coated with the first metal, a surface of the reference electrode having an average roughness (Rₐ)≤1 μm, the reference electrode having a width ≥0.5 mm and a length that is greater than or equal to the width;
a counter electrode comprising a foil of a second metal or a coated foil that is coated with the second metal; and
a variable resistor,
wherein
(i) the reference electrode and the counter electrode are in a spaced-apart relationship,
(ii) the reference electrode is configured to be electrically coupled directly or indirectly to a negative (−) power terminal of an external power source,
(iii) the counter electrode is configured to be electrically coupled directly or indirectly to a positive (+) power terminal of the external power source,
(iv) the variable resistor comprises a first terminal that is electrically coupled to the counter electrode or to the reference electrode, and a second terminal that is configured to be electrically coupled to a power terminal of the external power source, and
(v) the first metal comprises a hydrogen evolution reaction electrocatalyst.

2. The reference electrode assembly of claim 1, wherein:
(i) the first metal and the second metal independently comprise Pt, Au, Pd, Ir, Rh, or any combination thereof; or
(ii) the coated foil comprises Al foil, Cu foil, Ni foil, Ag foil, or an alloy foil comprising any two or more of Al, Cu, Ni, and Ag; or
(iii) both (i) and (ii).

3. The reference electrode assembly of claim 1, wherein the first metal and the second metal are Pt.

4. The reference electrode assembly of claim 1, wherein the counter electrode has:
(i) an average roughness (Rₐ)≤1 μm; or
(ii) a width ≥0.5 mm; or
(iii) a length that is greater than or equal to the width; or
(iv) any two or more of (i), (ii), and (iii).

5. The reference electrode assembly of claim 1, wherein the Rₐ the reference electrode is ≥300 nm.

6. The reference electrode assembly of claim 1, wherein the width of the reference electrode is ≤1 mm.

7. The reference electrode assembly of claim 1, wherein the length of the reference electrode is ≤5 mm.

8. The reference electrode assembly of claim 1, wherein each of the reference electrode and the counter electrode independently has a width of from 1 mm to 30 mm and a length of ≥5 mm.

9. The reference electrode assembly of claim 8, wherein each of the reference electrode and the counter electrode independently has a width of from 3 mm to 20 mm.

10. The reference electrode assembly of claim 1, wherein:
a thickness of the reference electrode is less than the width of the reference electrode and also is ≤3 mm; and
a thickness of the counter electrode is less than a width of the counter electrode and also is ≤3 mm.

11. The reference electrode assembly of claim 1, wherein the counter and reference electrodes are positioned adjacent to one another and are separated by a void space of from 1 mm to 30 mm, as measured from adjacent edge surfaces of the reference and counter electrodes.

12. The reference electrode assembly of claim 1, wherein the variable resistor has a maximum resistance of 10 MΩ.

13. The reference electrode assembly of claim 1, wherein:
(i) the first metal-coated foil comprises a substrate foil and a coating of the first metal on at least one surface of the substrate foil, the coating of the first metal having a thickness of from 1 μm to 2 mm; or
(ii) the second metal-coated foil comprises a substrate foil and a coating of the second metal on at least one surface of the substrate foil, the coating of the second metal having a thickness of from 1 μm to 2 mm; or
(iii) both (i) and (ii).

14. The reference electrode assembly of claim 1, wherein the first and second metals are the same, Rₐ values of the reference and counter electrodes are the same, widths of the reference and counter electrodes are the same, lengths of the reference and counter electrodes are the same, and thicknesses of the reference and counter electrodes are the same.

15. A reference electrode assembly, comprising:
a reference electrode and a counter electrode, each of the reference and counter electrodes comprising a foil of a metal or a coated foil that is coated with the metal, a surface of each of the reference and counter electrodes having an average roughness Rₐ≤1 μm, and each of the reference and counter electrodes having a thickness ≤3 mm, a width of from 0.5 mm to 30 mm, and a length of from 5 mm to 40 mm, wherein the length is greater than or equal to the width; and
a variable resistor,
wherein
(i) the reference electrode and the counter electrode are in a spaced-apart relationship with a void space between the reference electrode and the counter electrode of from 1 mm to 30 mm, as measured from adjacent edge surfaces of the counter and reference electrodes,
(ii) the reference electrode is configured to be electrically coupled directly or indirectly to a negative (−) power terminal of an external power source,
(iii) the counter electrode is configured to be electrically coupled directly or indirectly to a positive (+) power terminal of the external power source,
(iv) the variable resistor comprises a first terminal that is electrically coupled to the reference electrode or to the counter electrode, and a second terminal that is configured to be electrically coupled to a power terminal of the external power source, and
(v) the metal comprises a hydrogen evolution reaction electrocatalyst.

16. The reference electrode assembly of claim 15, wherein the reference electrode and the counter electrode comprise Pt foil or a Pt-coated foil, and the Rₐ of each of the reference and counter electrodes is ≤300 nm.

17. The reference electrode assembly of claim 15, wherein the widths of the reference and counter electrodes are the same, the lengths of the reference and counter electrodes are the same, and the thicknesses of the reference and counter electrodes are the same.

18. The reference electrode assembly of claim 15, wherein the variable resistor has a maximum resistance of 10 MΩ.

19. A redox flow battery system, comprising:
a cathode;
an anode;
a separator positioned between the cathode and the anode, the separator comprising two ion-conductive membranes; and
a reference electrode assembly according to claim 1, wherein at least a portion of the reference electrode and at least a portion of the counter electrode are positioned between the two ion-conductive membranes of the separator.

20. The redox flow battery system of claim 19, wherein distal ends of the reference and counter electrodes of the reference electrode assembly are spaced apart from adjacent surfaces of the cathode and the anode by a distance of at least 2 mm.
